(19) United States
(12) Patent Application Publication
(10) Pub. No.: US 2008/0030524 A1
(43) Pub. Date: Feb. 7, 2008

(54) METHOD AND APPARATUS FOR IMAGING DISPLAY PANEL AND METHOD FOR MANUFACTURING DISPLAY PANEL

(75) Inventor: Naoko Toyoshima, Kanagawa-ken (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/771,535

(22) Filed: Jun. 29, 2007

(30) Foreign Application Priority Data
Jun. 30, 2006 (JP) 2006-182546

(51) Int. Cl. G02F 1/13

(52) U.S. Cl. 345/660; 345/522; 445/23

(57) ABSTRACT

An imaged picture is obtained by imaging the display panel having a plurality of periodically arranged image elements by an imaging device having a plurality of periodically arranged imaging components, by imaging each image element of the display panel by a plurality of the imaging components. Then a reduced picture is created by specifying position and area of each region including a plurality of pixels consecutively arranged in the imaged picture randomly in a prescribed range and combining the plurality of pixels in the region into one pixel.

### CROSS-REFERENCE TO RELATED APPLICATIONS

This application is based upon and claims the benefit of priorities from the prior Japanese Patent Application No. 2006-182546, filed on Jun. 30, 2006; the entire contents of which are incorporated herein by reference.

### BACKGROUND OF THE INVENTION

1. Field of the Invention

This invention relates to a method and apparatus for imaging a display panel and method for manufacturing display panel, and more particularly to a method and apparatus for imaging a display panel and method for manufacturing display panel having a plurality of periodically arranged image elements by an imaging device having a plurality of periodically arranged imaging components.

2. Background Art

Conventionally, in manufacturing a display panel such as LCD (Liquid Crystal Display), the assembled display panel is inspected for unevenness and other defects. In a recently proposed technique, a CCD (Charge-Coupled Device) or other imaging device is used to image the display panel under inspection for automatically detecting defects on the basis of the picture obtained by this imaging.

However, when an LCD or other display panel having periodically arranged image elements is imaged by a CCD or other imaging device having periodically arranged imaging components, the arrangement period of the image elements may interfere with the arrangement period of the imaging components to produce moire (interference fringes) in the obtained picture. If moire occurs in the picture, it is difficult to detect unevenness, that is, defects having low contrast, from the picture.

In this respect, JP 2005-024503A, for example, proposes a technique for imaging a display panel while moving the display panel relative to the imaging device. Here the moving distance is set to one period or more of the imaging component. Then, according to JP 2005-024503A, the picture signal of each pixel is spatially integrated, and hence moire can be decreased.

However, in the technique disclosed in JP 2005-024503A, unfortunately, the imaged picture is spatially averaged, and hence the resolution of the picture is decreased.

### SUMMARY OF THE INVENTION

According to an aspect of the invention, there is provided a method for imaging a display panel having a plurality of periodically arranged image elements by an imaging device having a plurality of periodically arranged imaging components, the method comprising: obtaining an imaged picture by imaging the display panel, by imaging each image element of the display panel by a plurality of the imaging components; and creating a reduced picture by specifying position and area of each region including a plurality of pixels consecutively arranged in the imaged picture randomly in a prescribed range and combining the plurality of pixels in the region into one pixel.

According to another aspect of the invention, there is provided an apparatus for imaging a display panel having a plurality of periodically arranged image elements, the apparatus comprising: an imaging unit, having a plurality of periodically arranged imaging components, the imaging unit being configured to obtain an imaged picture by imaging the display panel by imaging each image element of the display panel by a plurality of the imaging components; and a computing unit configured to create a reduced picture by specifying position and area of each region including a plurality of pixels consecutively arranged in the imaged picture randomly in a prescribed range and combining the plurality of pixels in the region into one pixel.

According to another aspect of the invention, there is provided a method for manufacturing a display panel comprising: assembling a display panel having a plurality of periodically arranged image elements; and inspecting the display panel, the step of the inspecting the display panel including: imaging the display panel, the step of imaging the display panel including: obtaining an imaged picture by imaging the display panel by an imaging device having a plurality of periodically arranged imaging components, by imaging each image element of the display panel by a plurality of the imaging components; and creating a reduced picture by specifying position and area of each region including a plurality of pixels consecutively arranged in the imaged picture randomly in a prescribed range and combining the plurality of pixels in the region into one pixel; and assessing the display panel based on the result of the imaging.

### BRIEF DESCRIPTION OF THE DRAWINGS

FIG. 1 is a block diagram illustrating an imaging apparatus according to an embodiment of the invention.

FIG. 2 illustrates how the image elements of the display panel projected on the imaging plane of the imaging unit is related to the imaging components of the camera.

FIG. 3 is a flow chart illustrating a method for inspecting unevenness according to this embodiment.

FIG. 4 illustrates the relationship between the image elements of the display panel and the composite unit region.

### DETAILED DESCRIPTION OF THE INVENTION

An embodiment of the invention will now be described with reference to the drawings.

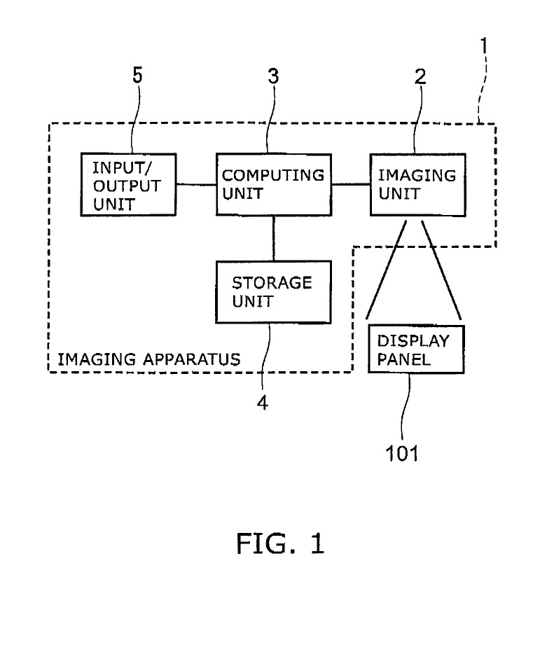

As shown in FIG. 1, the imaging apparatus 1 according to this embodiment is an apparatus for imaging a display panel 101. The display panel 101 is illustratively an FPD (Flat Panel Display) having periodically arranged image elements, for example, LCD. Here the “image element” of a display panel refers to a basic display unit composed of a set of RGB pixels. The imaging apparatus 1 comprises an imaging unit 2, a computing unit 3, a storage unit 4, and an input/output unit 5. The computing unit 3 is connected to the imaging unit 2, the storage unit 4, and the input/output unit 5.

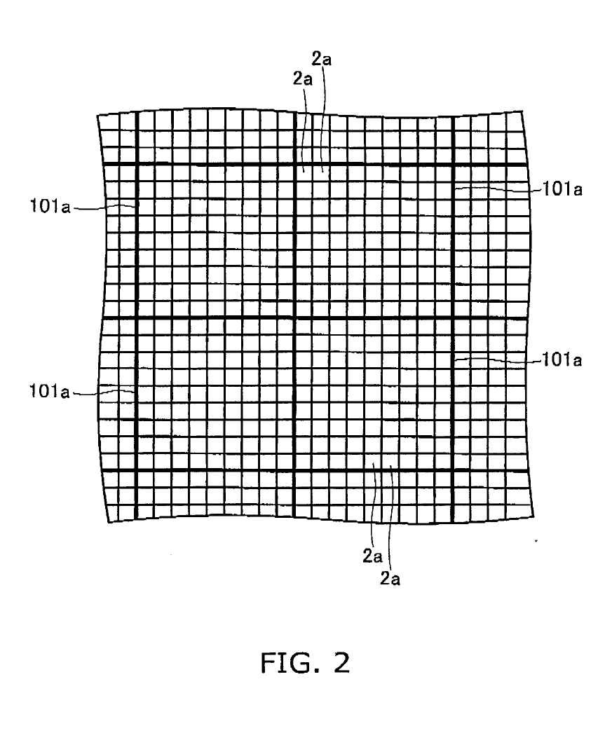

The imaging unit 2 serves to image the display panel 101 for obtaining an imaged picture. The imaging unit 2 includes a CCD, for example, as an imaging device (not shown) having periodically arranged imaging components. The imaging unit 2 also includes an optical system (not shown) for focusing light on the imaging device. The arrangement density of imaging components in the imaging device is greater than the arrangement density of image elements in the picture of the display panel 101 projected on the imaging plane of the imaging unit 2. Thus the imaging unit 2 images each image element of the display panel 101 by a plurality of imaging components. For example, as shown in FIG. 2, for a picture of one image element 101a of the display panel 101 projected on the imaging plane of the imaging unit 2, a total of 81 imaging components 2a of the imaging unit 2 are arranged as a 9×9 matrix.

The computing unit 3 serves to reduce the imaged picture obtained by the imaging unit 2 to create a reduced picture Specifically, a plurality of consecutively arranged pixels in the imaged picture are combined into one pixel to create a reduced picture. Here the region including a plurality of pixels arranged in the imaged picture that are to be combined into one pixel by reduction is referred to as a “composite unit region”. The computing unit 3 specifies the position and area of each composite unit region randomly in a prescribed range. The computing unit 3 is illustratively configured as a CPU (Central Processing Unit) of a personal computer, and illustratively also serves as a controller for the imaging unit 2 and the storage unit 4.

The storage unit 4 is a device for storing the imaged picture obtained by the imaging operation of the imaging unit 2 and the reduced picture created by the computing unit 3. The storage unit 4 is illustratively configured as an HDD (Hard Disk Drive) or other storage device.

The input/output unit 5 is an interface with a user, serving to input commands to the computing unit 3 and to display information outputted from the computing unit 3. The input/output unit 5 is illustratively composed of a keyboard and a display. The computing unit 3, the storage unit 4, and the input/output unit 5 may be configured as a single personal computer.

Next, a description is given of the operation of the imaging apparatus according to this embodiment configured as described above, that is, a method for imaging a display panel according to this embodiment.

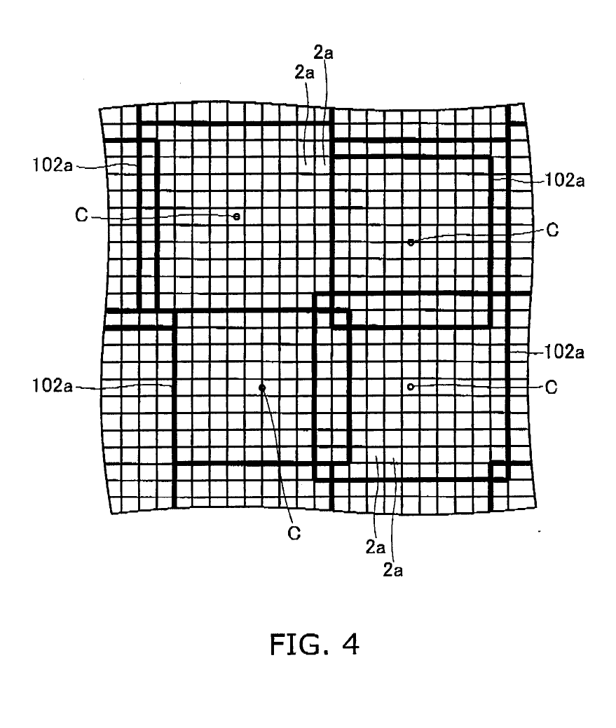

The following description will be made with reference to FIGS. 1 to 4.

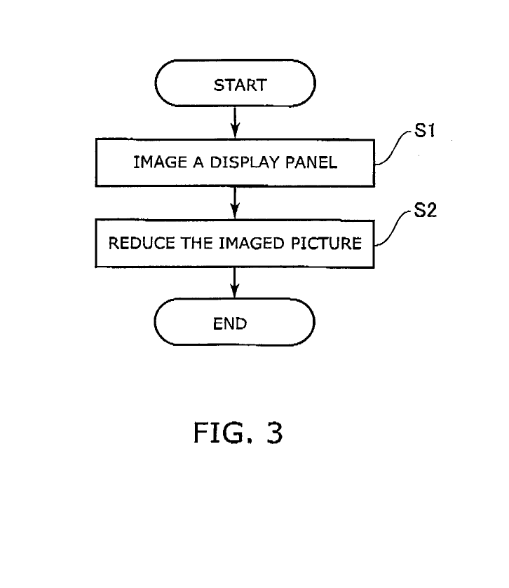

First, as shown in step S1 of FIG. 3, the imaging unit 2 of the imaging apparatus 1 images a display panel 101. Here, each image element of the display panel 101 is imaged by a plurality of imaging components, For example, as shown in FIG. 2, each image element 101a of the display panel 101 is imaged by 81 imaging components 2a illustratively arranged as a 9×9 matrix. Thus the imaging condition satisfies the sampling theorem, and the imaged picture is free from moire due to interference between the arrangement period of the image elements 101a and the arrangement period of the imaging components 2a. The imaged picture thus obtained is outputted to the computing unit 3.

The imaged picture has higher resolution than the image elements of the display panel, and even the structure of each image element is imaged. Thus it is unsuitable to extraction of macroscopic defects such as unevenness. Furthermore, the imaged picture has a large data size and is inconvenient to handle.

Thus, next, as shown in step S2 of FIG. 3, the computing unit 3 reduces the imaged picture to create a reduced picture. Specifically, a plurality of consecutively arranged pixels in the imaged picture are combined into one pixel in the reduced picture. More specifically, an average of 81 imaged pixels 2a consecutively arranged on average as a 9×9 matrix are combined into one pixel to reduce the resolution of the picture, so that one pixel of the reduced picture corresponds approximately to one image element 101a of the display panel 101.

However, if the imaged picture is uniformly reduced, moire occurs in the reduced picture. For this reason, the area and the position of the center C of a composite unit region 102a, that is, a region in the unreduced picture (imaged picture) to be reduced to one pixel, is specified randomly in a prescribed range. For example, the area of a composite unit region is specified randomly in a range from about 9×9 to 11×11 pixel region, and the position of the center C is specified randomly in a range of about one pixel on the left, right, top, and bottom of the reference position. Furthermore, reduction of the imaged picture is weighted by a Gauss function, the coefficients of which are also randomly specified.

Specifically, let N denote the reduction ratio of the picture, let p(x,y) denote the pixel value of a pixel located at coordinates (x,y) in the reduced picture, let P(X,Y) denote the pixel value of a pixel located at coordinates (X,Y) in the imaged picture, let W(i,j) denote a weighting function for a pixel located at coordinates (i,j) in each picture unit region of the imaged picture, the weighting function being symmetric with respect to origin (0,0), let σ denote the standard deviation, let rnd1, rnd2, and rnd3 denote random numbers taking random values ranging from −1 to +1, and let C₁, C₂, and C₃ be constants. The pixel value p(x,y) in the reduced picture is calculated by the following formulas 1 and 2. The following formulas 3 to 8 are derived from the following formulas 1 and 2.

$$\begin{matrix}p ( x , y ) = \frac{{\sum }_{j = 0}^{3 N - 1} {\sum }_{i = 0}^{3 N - 1} W ( i , j ) \times P ( Nx + i , Ny + j )}{{\sum }_{j = 0}^{3 N - 1} {\sum }_{i = 0}^{3 N - 1} W ( i , j )} & ( 1 ) \\ W ( i , j ) = {exp [ - \frac{{( i + \frac{N}{2} + {C}_{1} \times rnd 1 )}^{2} + {( j + \frac{N}{2} + {C}_{2} \times rnd 2 )}^{2}}{2 \times {\{ σ \times ( 1 + {C}_{3} \times rnd 3 ) \}}^{2}} ]}^{2} & ( 2 ) \\ p ( x , y ) = {\int }_{sj}^{ej} {\int }_{si}^{ei} W ( i , j ) \times P ( Nx + \frac{N}{2} + i , Ny + \frac{N}{2} + j ) ⅆ i ⅆ j & ( 3 ) \\ si = - \frac{N}{2} ( 1 + {C}_{3} \times rnd 3 ) + {C}_{1} \times rnd 1 & ( 4 ) \\ ei = \frac{N}{2} ( 1 + {C}_{3} \times rnd 3 ) + {C}_{1} \times rnd 1 & ( 5 ) \\ sj = - \frac{N}{2} ( 1 + {C}_{3} \times rnd 3 ) + {C}_{2} \times rnd 2 & ( 6 ) \\ ej = \frac{N}{2} ( 1 + {C}_{3} \times rnd 3 ) + {C}_{2} \times rnd 2 & ( 7 ) \\ {\int }_{sj}^{ej} {\int }_{si}^{ei} W ( i , j ) ⅆ i ⅆ j = 1.0 & ( 8 )\end{matrix}$$

Thus a reduced picture based on the imaged picture is created. Then the reduced picture is subjected to geometrical correction and contrast correction as needed. Thus a picture free from moire can be obtained

According to this embodiment, when the imaging unit images a display panel to obtain an imaged picture in step S1 of FIG. 3, each image element of the display panel is imaged by a plurality of imaging components. Hence the imaged picture satisfies the sampling theorem and is free from moire. Furthermore, when the imaged picture is reduced to create a reduced picture in step S2, the position and area of each composite unit region are specified randomly in a prescribed range. Thus the periodicity of the picture is destroyed, and moire can be avoided also in the reduced picture.

Also in the picture after reduction (reduced picture), one image element of the display panel corresponds approximately to one imaged pixel, ensuring sufficiently high resolution. Thus, according to this embodiment, it is possible to obtain a picture of a display panel with high resolution and free from moire.

The above mentioned method for imaging a display panel according to this embodiment can perform for manufacturing a display panel. This is, a method for manufacturing the above mentioned display panel has assembling a display panel having a plurality of periodically arranged image elements and inspecting the display panel. The step of the inspecting the display panel has imaging the display panel and assessing the display panel based on the result of the imaging. And, method for imaging a display panel according to this embodiment can perform in the step of imaging the display panel. This is, the step of imaging the display panel has obtaining an imaged picture by imaging the display panel by an imaging device having a plurality of periodically arranged imaging components and creating a reduced picture. The obtaining an imaged picture is performed by imaging each image element of the display panel by a plurality of the imaging components. And, the creating a reduced picture is performed by specifying position and area of each region including a plurality of pixels consecutively arranged in the imaged picture randomly in a prescribed range and combining the plurality of pixels in the region into one pixel.

The invention has been described with reference to the embodiment. However, the invention is not limited to this embodiment. For example, in the above embodiment, the imaging apparatus illustratively images an LCD. However, the invention is not limited thereto, but it is also possible to image a PDP (Plasma Display Panel), for example. Any modification and any addition and/or deletion of components in the above embodiment appropriately made by those skilled in the art are also encompassed within the scope of the invention as long as they do not depart from the spirit of the invention.

1. A method for imaging a display panel having a plurality of periodically arranged image elements by an imaging device having a plurality of periodically arranged imaging components, the method comprising:
obtaining an imaged picture by imaging the display panel, by imaging each image element of the display panel by a plurality of the imaging components; and
creating a reduced picture by specifying position and area of each region including a plurality of pixels consecutively arranged in the imaged picture randomly in a prescribed range and combining the plurality of pixels in the region into one pixel.

2. The method for imaging a display panel according to claim 1, wherein the step of creating a reduced picture includes calculating a pixel value p(x,y) in the reduced picture by following formulas:
$$\begin{matrix}p ( x , y ) = {\int }_{sj}^{ej} {\int }_{si}^{ei} W ( i , j ) \times P ( Nx + \frac{N}{2} + i , Ny + \frac{N}{2} + j ) ⅆ i ⅆ j \\ si = - \frac{N}{2} ( 1 + {C}_{3} \times rnd 3 ) + {C}_{1} \times rnd 1 \\ ei = \frac{N}{2} ( 1 + {C}_{3} \times rnd 3 ) + {C}_{1} \times rnd 1 \\ sj = - \frac{N}{2} ( 1 + {C}_{3} \times rnd 3 ) + {C}_{2} \times rnd 2 \\ ej = \frac{N}{2} ( 1 + {C}_{3} \times rnd 3 ) + {C}_{2} \times rnd 2 \\ {\int }_{sj}^{ej} {\int }_{si}^{ei} W ( i , j ) ⅆ i ⅆ j = 1.0\end{matrix}$$
where N is a reduction ratio of the picture, p(x,y) is the pixel value of a pixel located at coordinates (x,y) in the reduced picture, P(X,Y) is a pixel value of a pixel located at coordinates (X,Y) in the imaged picture, W(i,j) is a weighting function for a pixel located at coordinates (i,j) in the region including the plurality of pixels in the imaged picture, the weighting function being symmetric with respect to origin (0,0), rnd1, rnd2, and rnd3 are random numbers taking random values ranging from −1 to +1, and C₁, C₂, and C₃ are constants.

3. The method for imaging a display panel according to claim 1, wherein the step of creating a reduced picture includes calculating a pixel value p(x,y) in the reduced picture by following formulas:
$$\begin{matrix}p ( x , y ) = \frac{{\sum }_{j = 0}^{3 N - 1} {\sum }_{i = 0}^{3 N - 1} W ( i , j ) \times P ( Nx + i , Ny + j )}{{\sum }_{j = 0}^{3 N - 1} {\sum }_{i = 0}^{3 N - 1} W ( i , j )} \\ W ( i , j ) = {exp [ - \frac{{( i + \frac{N}{2} + {C}_{1} \times rnd 1 )}^{2} + {( j + \frac{N}{2} + {C}_{2} \times rnd 2 )}^{2}}{2 \times {\{ σ \times ( 1 + {C}_{3} \times rnd 3 ) \}}^{2}} ]}^{2}\end{matrix}$$
where N is a reduction ratio of the picture, p(x,y) is the pixel value of a pixel located at coordinates (x,y) in the reduced picture, P(X,Y) is a pixel value of a pixel located at coordinates (X,Y) in the imaged picture, W(i,j) is a weighting function for a pixel located at coordinates (i,j) in the region including the plurality of pixels in the imaged picture, the weighting function being symmetric with respect to origin (0,0), rnd1, rnd2, and rnd3 are random numbers taking random values ranging from −1 to +1, and C₁, C₂, and C₃ are constants.

4. The method for imaging a display panel according to claim 1, wherein the step of creating a reduced picture includes specifying the position of the center of the region including a plurality of pixels consecutively arranged randomly in a range of about one pixel on the left, right, top, and bottom of the reference position.

5. The method for imaging a display panel according to claim 1, wherein the image element has a set of RGB pixels.

6. The method for imaging a display panel according to claim 1, wherein the display panel is a Flat Panel Display.

7. The method for imaging a display panel according to claim 6, wherein the Flat Panel Display is a Liquid Crystal Display.

8. An apparatus for imaging a display panel having a plurality of periodically arranged image elements, the apparatus comprising:
an imaging unit having a plurality of periodically arranged imaging components, the imaging unit being configured to obtain an imaged picture by imaging the display panel by imaging each image element of the display panel by a plurality of the imaging components; and
a computing unit configured to create a reduced picture by specifying position and area of each region including a plurality of pixels consecutively arranged in the imaged picture randomly in a prescribed range and combining the plurality of pixels in the region into one pixel.

9. The apparatus for imaging a display panel according to claim 8, wherein the computing unit calculates a pixel value p(x,y) in the reduced picture by following formulas:
$$\begin{matrix}p ( x , y ) = {\int }_{sj}^{ej} {\int }_{si}^{ei} W ( i , j ) \times P ( Nx + \frac{N}{2} + i , Ny + \frac{N}{2} + j ) ⅆ i ⅆ j \\ si = - \frac{N}{2} ( 1 + {C}_{3} \times rnd 3 ) + {C}_{1} \times rnd 1 \\ ei = \frac{N}{2} ( 1 + {C}_{3} \times rnd 3 ) + {C}_{1} \times rnd 1 \\ sj = - \frac{N}{2} ( 1 + {C}_{3} \times rnd 3 ) + {C}_{2} \times rnd 2 \\ ej = \frac{N}{2} ( 1 + {C}_{3} \times rnd 3 ) + {C}_{2} \times rnd 2 \\ {\int }_{sj}^{ej} {\int }_{si}^{ei} W ( i , j ) ⅆ i ⅆ j = 1.0\end{matrix}$$
where N is a reduction ratio of the picture, p(x,y) is the pixel value of a pixel located at coordinates (x,y) in the reduced picture, P(X,Y) is a pixel value of a pixel located at coordinates (X,Y) in the imaged picture, W(i,j) is a weighting function for a pixel located at coordinates (i,j) in the region including the plurality of pixels in the imaged picture, the weighting function being symmetric with respect to origin (0,0), rnd1, rnd2, and rnd3 are random numbers taking random values ranging from −1 to +1, and C₁, C₂, and C₃ are constants.

10. The apparatus for imaging a display panel according to claim 8, wherein the computing unit calculates a pixel value p(x,y) in the reduced picture by following formulas:
$$\begin{matrix}p ( x , y ) = \frac{{\sum }_{j = 0}^{3 N - 1} {\sum }_{i = 0}^{3 N - 1} W ( i , j ) \times P ( Nx + i , Ny + j )}{{\sum }_{j = 0}^{3 N - 1} {\sum }_{i = 0}^{3 N - 1} W ( i , j )} \\ W ( i , j ) = {exp [ - \frac{{( i + \frac{N}{2} + {C}_{1} \times rnd 1 )}^{2} + {( j + \frac{N}{2} + {C}_{2} \times rnd 2 )}^{2}}{2 \times {\{ σ \times ( 1 + {C}_{3} \times rnd 3 ) \}}^{2}} ]}^{2}\end{matrix}$$
where N is a reduction ratio of the picture, p(x,y) is the pixel value of a pixel located at coordinates (x,y) in the reduced picture, P(X,Y) is a pixel value of a pixel located at coordinates (X,Y) in the imaged picture, W(i,j) is a weighting function for a pixel located at coordinates (i,j) in the region including the plurality of pixels in the imaged picture, the weighting function being symmetric with respect to origin (0,0), rnd1, rnd2, and rnd3 are random numbers taking random values ranging from −1 to +1, and C₁, C₂, and C₃ are constants.

11. The apparatus for imaging a display panel according to claim 8, wherein the computing unit specifies the position of the center of the region including a plurality of pixels consecutively arranged randomly in a range of about one pixel on the left, right, top, and bottom of the reference position,

12. The apparatus for imaging a display panel according to claim 8, wherein the imaging unit includes a Charge-Coupled Device.

13. The apparatus for imaging a display panel according to claim 8, wherein the display panel is a Flat Panel Display.

14. The apparatus for imaging a display panel according to claim 13, wherein the Flat Panel Display is a Liquid Crystal Display.

15. A method for manufacturing a display panel comprising:
assembling a display panel having a plurality of periodically arranged image elements; and
inspecting the display panel, the step of the inspecting the display panel including:
imaging the display panel, the step of imaging the display panel including:
obtaining an imaged picture by imaging the display panel by an imaging device having a plurality of periodically arranged imaging components, by imaging each image element of the display panel by a plurality of the imaging components; and
creating a reduced picture by specifying position and area of each region including a plurality of pixels consecutively arranged in the imaged picture randomly in a prescribed range and combining the plurality of pixels in the region into one pixel; and
assessing the display panel based on the result of the imaging.

16. The method for manufacturing a display panel according to claim 15, wherein the step of creating a reduced picture includes calculating a pixel value p(x,y) in the reduced picture by following formulas:
$$\begin{matrix}p ( x , y ) = {\int }_{sj}^{ej} {\int }_{si}^{ei} W ( i , j ) \times P ( Nx + \frac{N}{2} + i , Ny + \frac{N}{2} + j ) ⅆ i ⅆ j \\ si = - \frac{N}{2} ( 1 + {C}_{3} \times rnd 3 ) + {C}_{1} \times rnd 1 \\ ei = \frac{N}{2} ( 1 + {C}_{3} \times rnd 3 ) + {C}_{1} \times rnd 1 \\ sj = - \frac{N}{2} ( 1 + {C}_{3} \times rnd 3 ) + {C}_{2} \times rnd 2 \\ ej = \frac{N}{2} ( 1 + {C}_{3} \times rnd 3 ) + {C}_{2} \times rnd 2 \\ {\int }_{sj}^{ej} {\int }_{si}^{ei} W ( i , j ) ⅆ i ⅆ j = 1.0\end{matrix}$$
where N is a reduction ratio of the picture, p(x,y) is the pixel value of a pixel located at coordinates (x,y) in the reduced picture, P(X,Y) is a pixel value of a pixel located at coordinates (X,Y) in the imaged picture, W(i,j) is a weighting function for a pixel located at coordinates (i,j) in the region including the plurality of pixels in the imaged picture, the weighting function being symmetric with respect to origin (0,0), rnd1, rnd2, and rnd3 are random numbers taking random values ranging from −1 to +1, and C₁, C₂, and C₃ are constants.

17. The method for manufacturing a display panel according to claim 15, wherein the step of creating a reduced picture includes calculating a pixel value p(x,y) in the reduced picture by following formulas;
$$\begin{matrix}p ( x , y ) = \frac{{\sum }_{j = 0}^{3 N - 1} {\sum }_{i = 0}^{3 N - 1} W ( i , j ) \times P ( Nx + i , Ny + j )}{{\sum }_{j = 0}^{3 N - 1} {\sum }_{i = 0}^{3 N - 1} W ( i , j )} \\ W ( i , j ) = {exp [ - \frac{{( i + \frac{N}{2} + {C}_{1} \times rnd 1 )}^{2} + {( j + \frac{N}{2} + {C}_{2} \times rnd 2 )}^{2}}{2 \times {\{ σ \times ( 1 + {C}_{3} \times rnd 3 ) \}}^{2}} ]}^{2}\end{matrix}$$
where N is a reduction ratio of the picture, p(x,y) is the pixel value of a pixel located at coordinates (x,y) in the reduced picture, P(X,Y) is a pixel value of a pixel located at coordinates (X,Y) in the imaged picture, W(i,j) is a weighting function for a pixel located at coordinates (i,j) in the region including the plurality of pixels in the imaged picture, the weighting function being symmetric with respect to origin (0,0), rnd1, rnd2, and rnd3 are random numbers taking random values ranging from −1 to +1, and C₁, C₂, and C₃ are constants.

18. The method for manufacturing a display panel according to claim 15, wherein the step of creating a reduced picture includes specifying the position of the center of the region including a plurality of pixels consecutively arranged randomly in a range of about one pixel on the left, right, top, and bottom of the reference position.

19. The method for manufacturing a display panel according to claim 15, wherein the display panel is a flat panel display.

20. The method for manufacturing a display panel according to claim 19, wherein the flat panel display is a liquid crystal display.
